(19) United States
(12) Patent Application Publication
(10) Pub. No.: US 2010/0065491 A1
(43) Pub. Date: Mar. 18, 2010

(54) Self-supporting unit of synthetic aggregate and method and apparatus for making same

(76) Inventors: HARRY BUSSEY, JR., Marco Island, FL (US); BUDDY HARRY BUSSEY, III, Atlantic Highlands, NJ (US)

Correspondence Address: CARELLA,BYRNE,BAIN,GILFILLAN,CECCHI,;STEWART & OLSTEIN, 5 Becker Farm Road, Roseland, NJ, 07068, US

(21) Appl. No.: 12/584,425

(22) Filed: Sep. 4, 2009

Related U.S. Application Data
(60) Provisional application No. 61/190,952, filed on Sep. 4, 2008.

(51) Int. Cl. E03F 3/04; B32B 7/12; B32B 3/26; F16L 9/00; B65B 1/20

(52) U.S. Cl. 210/484; 428/317.1; 138/177; 141/73; 141/12

(57) ABSTRACT

The drainage element is initially made of cylindrical cross-section and shaped into a rectangular cross-section. A glue is sprayed onto the expanded polymeric elements during fabrication of the drainage element to maintain the rectangular cross-section when dried. The drainage element may be provided with a pipe, perforated or not, and end caps that close off the ends of the drainage element and that serve to connect to like drainage elements.

This application claims the benefit of Provisional Application 61/190,952, filed Sep. 4, 2008.

This invention relates to a self-supporting unit of synthetic aggregate and to a method and apparatus for making same. More particularly, this invention relates to self-supporting unit of synthetic aggregate for use in a drainage system or septic system.

As is known, drainage elements have been constructed of a perforated plastic pipe surrounded by loose aggregate, such as foam plastic elements, beads, and other light weight materials, that are kept in place by an enveloping sleeve of mesh or the like for use in a sewage field, water drainage field, roadside drainage ditches and the like. Various techniques have also been known for making such drainage elements in a manufacturing plant in lengths of 10 feet or more so that the individual drainage elements may then be shipped to a construction site for use. Examples of such techniques are described in U.S. Pat. Nos. 5,015,123; 5,154,543; 5,535,499; 5,657,527; and 6,173,483.

Typically, the drainage elements are formed with a cylindrical cross-section. Thus, when such drainage elements are placed in a trench in the field as part of an overall drainage system, the plane of the cross-section of the drainage element presented for drainage is limited to the diameter of the drainage element. That is to say, where the drainage element is used in a septic tank system, the effluent from a perforated pipe within the drainage unit is dispersed primarily downwardly under gravity and flows through the aggregate in a spread pattern from about a four o'clock position to an eight o'clock position, as viewed in cross-section.

In the case where the drainage element is used to draw off water from a field, the water typically permeates through the upper surfaces of the drainage element from about a ten o'clock position to a two o'clock position, as viewed in cross-section, into the perforated pipe. Further, where the pipe is perforated throughout the circumference, there is leakage of the water through the perforations located, at least, in the bottom half of the pipe back into the trench.

Where a trench is of large width, a pair of drainage elements would be placed side-by-side in the bottom of the trench. However, the effective areas of the two drainage elements for the passage of effluent or water from or into the perforated pipes is reduced. In order to increase the effective area of a drainage element, use may be made of a ground water drainage device, as described in U.S. Pat. No. 3,441,140, that is comprised of an elongated flat and flexible envelope that has been compartmentalized by joining the opposite walls thereof to each other along substantially their entire width at intervals and loosely filled with granules of water-insoluble material. The device is also described as capable of being bent and rolled up for ease of storage, transportation and the like.

U.S. Pat. No. 6,857,818 describes a bale-shaped drainage element. Such a drainage element may be readily stacked with like drainage elements during transportation and when being placed in a trench or the like for use in a drainage field of septic field.

Copending U.S. patent application Ser. No. 11/506,332 describes a method of making a drainage unit of ovate cross-sectional shape.

Accordingly, It is an object of this invention to provide a relatively simple technique for making preassembled drainage elements without the need for an enveloping sleeve and with or without pipes extending therethrough.

It is another object of the invention to provide a preassembled drainage element without the need for an enveloping sleeve and with or without a pipe extending therethrough.

It is another object of the invention to provide a method of making a preassembled drainage element of more efficient shape than a cylindrical drainage element.

It is another object of the invention to provide an economical and efficient method of making drainage elements.

It is another object of the invention to provide a self-supporting unit of synthetic aggregate that can be used for insulation.

Briefly, the invention provides a method of making a self-supporting unit comprising the steps of directing a flow of synthetic aggregate, such as expanded polymeric elements of polystyrene, having a coating of an adhesive thereon into a passageway of predetermined cross-sectional shape; moving the aggregate longitudinally along the passageway while pressing the elements of the aggregate against each other to form a cohesive mass having a cross-sectional shape corresponding to the cross-sectional shape of the passageway; passing the shaped cohesive mass of aggregate out of the passageway; and drying the shaped cohesive mass to dry the adhesive and to form a self-supporting unit.

In one embodiment, the adhesive used to adhere the elements of the self-supporting unit is a water soluble starch based adhesive that is of a nature to dissolve under the passage of water or a septic effluent through the unit.

In another embodiment, the adhesive used to adhere the elements of the self-supporting unit is a permanent type adhesive that remains in place throughout the life of the unit. In this embodiment, the porosity of the unit is less than in the first embodiment. As a result, less water is able to pass through the unit than in the embodiment using a water soluble adhesive.

In some embodiments, the aggregate may be moved into a sleeve of netting or a sleeve of porous membrane.

The invention also provides a self-supporting unit comprised of an aggregate, such as a plurality of expanded polymeric loose fill elements, and an adhesive on the elements of the aggregate that adheres the elements together into an elongated mass having a predetermined cross-sectional shape.

The cross-sectional shape of the self-supporting unit is selected from one of a triangular shape, a polygonal shape, a circular shape, an oval shape or any other shape suitable for the use of the unit. In this latter respect, the self-supporting unit may be used in a drainage ditch to drain water away to a remote location or in a septic trench to convey an effluent from a septic tank into a septic field. Also, the self-supporting unit may have a rectangular cross sectional with a width and height to be used as insulation between wall studs in the wall of a building. In this latter embodiment, the self-supporting unit can be placed within a sleeve that has flanges at opposite sides to permit the flanges to be stapled to the wall studs.

The self-supporting unit may also have a perforated pipe extending within the mass of adhered together elements for conducting a flow of liquid therethrough. In this embodiment, the self-supporting unit is particularly useful in a drainage field or a septic field.

When the self-supporting unit is used in a drainage system or septic system, the unit is placed in a ditch or trench and subsequently covered by a backfill. Once in place, water or an septic effluent passing through the unit dissolves the adhesive where the adhesive is a water soluble starch based adhesive. However, the backfill maintains the shape of the loose fill elements of the unit in the original shape of the unit.

The invention also provides a drainage element of non-circular cross-sectional shape that is comprised of a mass of loose fill elements of polymeric material disposed within a tube or sleeve having at least one water permeable peripheral section and having closed ends. The loose fill elements have a coating of an adhesive thereon adhering contiguous loose fill elements together to retain the non-circular shape.

In one embodiment, the drainage element may have a porous end cap or a perforated end cap secured to each end to retain the loose fill elements within the tube of material.

The drainage element may or may not be provided with a pipe that extends throughout the length of the element for coupling to a pipe of an adjacent drainage element. The pipe may also be perforated or not depending upon the ultimate use of the drainage element. Where an end cap is secured to each end of the drainage element, the end cap has an opening in communication with the pipe.

In one embodiment, the invention provides an apparatus wherein a tube of material having at least one water permeable section is positioned on a tubular sleeve and a free end of the tube of material is closed. This tube of material may be supplied in a predetermined length or may be delivered in a web form that is shaped into a tubular sleeve.

Next, a mass of expanded elements of polymeric material is supplied into the tube of material while the tube of material is simultaneously moved from the sleeve to form a tubular unit. The polymeric elements may be delivered in any suitable manner, such as pneumatically or mechanically, as by a rotating screw. After a predetermined length of the tubular unit has been formed, further delivery of the polymeric elements is stopped and the tube of material is closed on itself to retain the polymeric elements within the tube of material of the tubular unit, such as by placing a tie about the gathered together tube of material. The tube of material may then be cut in the middle of a gathered together section in a conventional manner to start the front end of the next tubular unit.

In accordance with the invention, an adhesive, such as a water soluble starch based adhesive, is sprayed onto the polymeric elements within the tubular unit for adhering the contiguous elements together. The adhesive may be sprayed onto the polymeric elements at the time that the elements are being supplied to the tube of material during fabrication of the tubular unit and, particularly, when the elements are supplied pneumatically.

Alternatively, the adhesive may be sprayed onto the loose fill elements after the tubular unit has been fabricated. Also, the tubular unit may be dipped in a bath of adhesive particularly where the tubular unit is formed with a sleeve of netting.

The tubular unit is then shaped into an approximately rectangular cross-sectional shape or any other suitable bale shape. During this time, the glue-coated loose fill elements are able to shift within the tube of material to adapt to the deformed cross-sectional shape of the unit.

Next, the shaped unit is dried for a sufficient length of time to have the contiguous polymeric elements adhere together to form a bale-shaped drainage element. Drying may take place at room temperature over the course of, for example, 4 to 5 hour or may take place in an appliance heated to about 120° F. until dry.

The shaped unit may be made in lengths, such as ten feet, for use as is or may be made in lengths that can be cut into discrete individual predetermined lengths to form a plurality of drainage elements. In the latter case, an end cap is secured over each untied end of a drainage unit to close the end so that the loose fill elements are retained in place.

In another embodiment, the apparatus employs a hopper for delivering a flow of expanded polymeric elements; means for spraying an adhesive onto the flow of polymeric elements; and a plurality of longitudinally arranged endless conveyor belts defining a passageway of predetermined cross-sectional shape for receiving a flow of polymeric elements from the hopper with adhesive thereon. The conveyor belts operate in synchronism for moving the polymeric elements longitudinally along the passageway while pressing the polymeric elements against each other to form a cohesive mass having a cross-sectional shape corresponding to the cross-sectional shape of the passageway and for expelling the cohesive mass as a self-supporting unit from the passageway.

Where the drainage unit is made with a pipe, each end cap is provided with an opening in alignment with the pipe within the drainage unit and a conventional coupling is provided to form a connection between the pipes of adjacent drainage units. Alternatively, each end cap may be configured to form a part of a coupling for interconnecting individual drainage units together lengthwise when in place, for example, in a trench.

The bale-shaped drainage elements that are made in accordance with the above described method may be readily stacked on each other for storage purposes and/or for transportation purposes. Likewise, the bale-shaped drainage elements may be easily stacked on each other within a trench or laid side-by-side in a minimum of space within a trench. Further, where the drainage elements are of a square cross-section with a given width, a greater amount of aggregate is provided relative to a drainage element of circular cross-section of that given width.

The bale-shaped drainage element may be made with a pipe, perforated or not, that extends through the element, such as described in U.S. Pat. No. 7,178,224.

After the drainage units have been placed in the ground, any water that passes into the mass of polymeric elements dissolves the water soluble starch based adhesive, where such an adhesive is used, bonding the elements together and washes the starch away. However, the shape of the drainage unit remains since the weight of the backfill associated with the drainage unit will tend to keep the polymeric elements from migrating and where the polymeric elements are encased in a sleeve, the sleeve keeps the polymeric elements from migrating.

These and other objects and advantages of the invention will become more apparent from the following detailed description taken in conjunction with the accompanying drawings wherein:

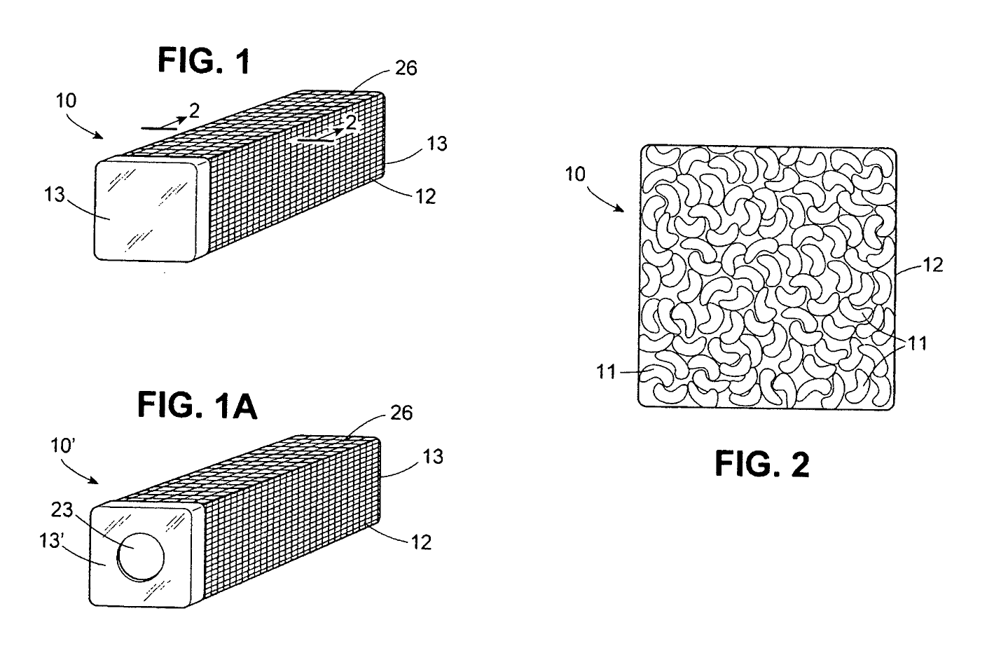

FIG. 1 illustrates a perspective view of a bale-shaped drainage element constructed in accordance with the invention;

FIG. 1A illustrates a perspective view of a modified drainage element in accordance with the invention.

FIG. 2 illustrates a schematic view of the loose fill elements within the drainage element of FIG. 1;

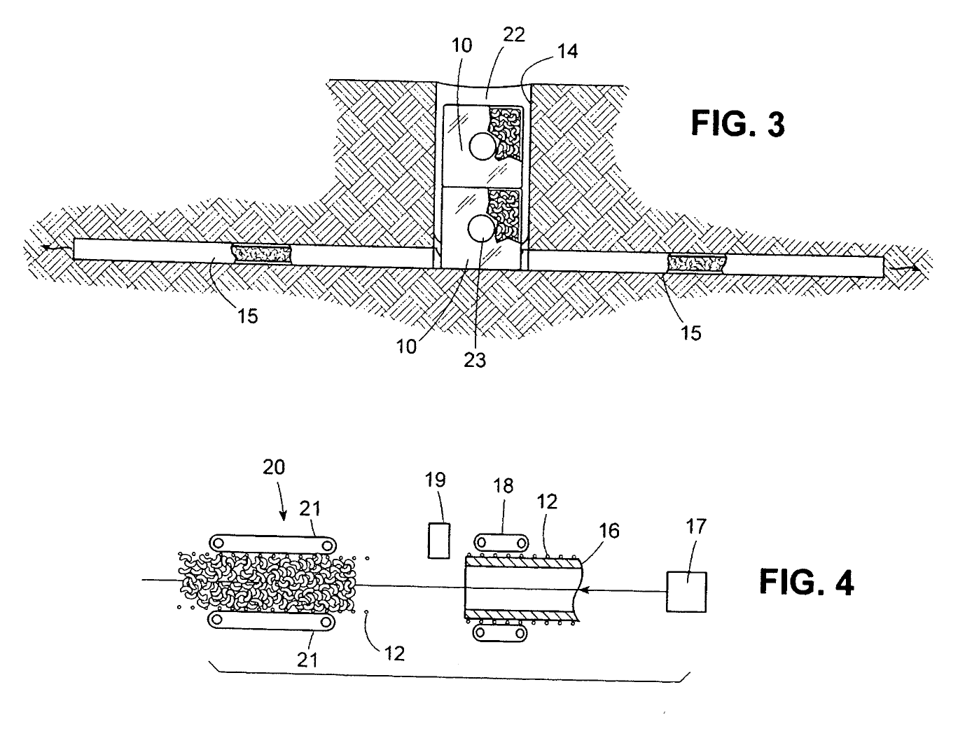

FIG. 3 illustrates a cross-section view of an arrangement of the drainage elements in a trench in accordance with the invention;

FIG. 4 illustrates a schematic view of an apparatus employed in the method of making a drainage element in accordance with the invention;

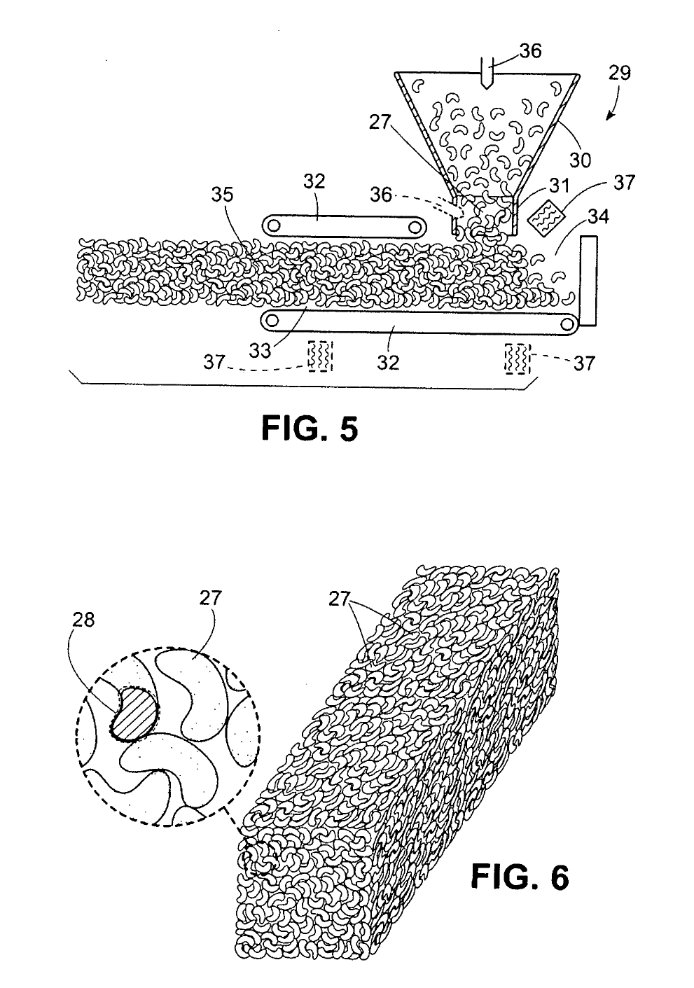

FIG. 5 illustrates a schematic view of a modified apparatus for making a self-supporting unit without a sleeve in accordance with the invention; and

FIG. 6 illustrates a partial cross-sectional view of a self-supporting unit constructed in accordance with the invention.

Referring to FIG. 1, the drainage element 10 is of an approximately rectangular cross-sectional shape with slightly rounded corners and of a length which is a multiple of the cross-sectional height or width. The drainage element 10 is formed of an aggregate of expanded (i.e. foamed) polymeric elements 11 (see FIG. 2) of any suitable shape, such as a crescent shape as illustrated, disposed within a tube or sleeve 12. In addition, a porous end cap 13 is secured over each end of the drainage element 10 to close the same. Each end cap 13 may be provided with holes (not shown) of a size to render the cap porous to the passage of water but not the expanded polymeric elements 11.

Referring to FIG. 4, in order to make a drainage element 10, an apparatus similar to that described in co-pending U.S. patent Ser. No. 11/506,332 filed Aug. 18, 2006 may be used. As described therein, use is made of an apparatus that includes a hopper (not shown) for receiving expanded polymeric elements, an elongated sleeve 16 that extends horizontally from the hopper and a blower 17 for blowing the expanded polymeric elements from the hopper into the sleeve 16. A capstan arrangement 18 near one end of the sleeve 16 may also be provided to restrain the tube 12 from being blown off the sleeve 23 under the force of the blower 17.

The apparatus also employs a tying and cutting apparatus 19 at the end of the sleeve 16 for closing the tube 12 on itself. Typically, the tube of material 16 has a diameter of 12¾ inches.

The tube of material 12 may be supplied in a predetermined length and rucked onto the sleeve 16 or may be delivered in a web form that is shaped into a tubular sleeve about the sleeve 16. In either embodiment, the tube of material 12 has at least one water permeable section.

During operation, after the free end of the tube of material 12 has closed, the blower 17 is activated so that a mass of expanded polymeric elements 11 is supplied into the tube of material 12 to form a tubular unit (not shown).

In accordance with the invention, the expanded polymeric elements 11 are supplied to the blower 17 with a coating of adhesive, such as a water soluble starch based adhesive supplied by Baker Adhesives of Newark, N.J. under Product #D-213, thereon for the subsequent adherence of the contiguous expanded polymeric elements 11 together. By way of example, the adhesive is sprayed onto the expanded polymeric elements 11 upstream of the blower 17 to form a wet coating on a substantial portion of the elements 11. Alternatively, the adhesive may be sprayed onto the expanded polymeric elements after a tubular unit has been formed or the tubular unit may be dipped into a bath of adhesive.

After a predetermined length of the tubular unit has been formed, the blower 17 is shut off so that further delivery of expanded polymeric elements 11 is stopped. The tube of material 12 is then closed via the tying and cutting apparatus 19 in order to retain the loose fill elements 11 within the closed tube of material 12. Thus, as the rear end of a tubular unit is being closed, the front end of the next tubular unit to be made is formed.

The resulting tubular unit is then shaped into a cross-sectional shape deformed from a circular shape, for example, into an approximately rectangular cross-sectional shape or any other suitable bale shape by being passed through a former 20, for example in the form of four conveyer belts 21 to cause the tubular unit to square up into an approximately 10 inch by 10 inch square unit. The conveyer belts 21 are disposed in parallel to form a square-shaped passage therebetween. Thus, during movement of the tubular unit between the pairs of conveyer belts 21, the top and bottom of the tubular unit are slightly compressed into a flattened shape while the two sides of the tubular unit are likewise compressed and deformed into a flattened shape. The resulting cross-section of the unit is thus approximately rectangular with slightly rounded corners.

The conveyor belts used may be of any suitable number to deform the tubular unit into other cross-sectional shapes, such as, a triangular shape, a hexagonal shape or other polygonal shape. Also, a single pair of conveyor belts may be used to deform the tubular unit into an oval shape.

Depending upon the diameter of the tubular unit which is formed, the conveyer belts 21 may be spaced at a greater or less distance apart in order to form a shapes of different sizes.

In addition, the conveyer belts 21 may be arranged at a slight angle to each other in order to define a passageway of constantly decreasing size.

During passage of the tubular unit through the former 20, the adhesive coated expanded polymeric elements 11 are able to shift within the tube of material 12 to adapt to the deformed cross-sectional shape of the tubular unit.

After forming, the shaped unit is dried at a temperature sufficient to cure the adhesive to thereby adhere the contiguous expanded polymeric elements 11 together in a shape-retaining manner. If of a suitable length, the shaped unit may then be used as is. Otherwise, the shaped unit is cut into discrete individual predetermined lengths to form a plurality of drainage elements 10 and an end cap 13 is secured over each exposed end of a drainage element 10 to close the exposed end of the drainage element 10.

Each end cap 13 may be vacuum formed, injection molded or blow molded out of plastic or any other suitable material including pressed paper, paper pulp or screen material or membrane. Each end cap 13 is sized to fit over the deformed end of the drainage unit 10 and may be secured in place by being glued to the end of the drainage element 10.

The end caps 13 allow the drainage elements 10 to butt against each other when placed in a drainage ditch, trench or the like. In order to allow water to pass from one drainage unit 10 to the next drainage unit 10, the end caps 13 may be made of a porous material or provided with holes (not shown) for the passage of water. In cases where the drainage elements are intended to store water in a drainage system, for example, at times when the surrounding soil is saturated, the lower parts of the end caps made be made solid in order to act as a dam to retain water within the drainage element until such time that the surrounding soil is able to absorb more water. In such cases, any excess of water within a drainage element would flow through the upper parts of the end caps 13 into the adjacent drainage element in order to flow off to a sewer system connected downstream of the drainage elements.

Referring to FIG. 3, two or more drainage elements 10 may be stacked vertically within a trench 14. As shown, the drainage elements 10 may connect with similar drainage units 15 that function as laterals to conduct water away from the trench 14. These lateral drainage units may be of smaller size and of a different shape.

After being placed within the trench 14 and covered with the usual backfill 22, any water that enters the drainage element 10 dissolves the adhesive thereby breaking the adhesive bond of the elements 11 to each other. However, the shape of the trench and the backfill maintains the basic shape of the drainage element as installed. In addition, water is able to easily pass through the loose fill elements.

Alternatively, the drainage element 10 may be made by an apparatus similar to that described in any one of U.S. Pat. Nos. 6,035,606; 6,588,184; and 6,745,547.

Referring to FIG. 1A, wherein the like reference characters indicate like parts as above, the drainage element 10′ may be formed with a pipe 23, perforated or not, that is centrally located or not. In this embodiment, the method of making the drainage unit 10′ is similar to that described above except that a perforated pipe feeder would be provided for delivering a continuous length perforated pipe within the sleeve 16 (see FIG. 4). When this option is used, the expanded polymeric elements 11 surround the pipe 23 in a circumferential manner. In addition, the tube of material 12 is tied directly to the pipe.

Alternatively, the drainage element 10′ may be made on an apparatus as described in U.S. Pat. No. 7,178,224 or published US Patent Applications 2006/0075620 and 2006/0283001.

Further, where the tube unit containing the pipe 23 is made of a length that can be cut into individual drainage elements 10′, the ends of the pipe 23 are exposed at each end of the drainage element 10′. Thereafter, an end cap 13′ is secured, as by gluing, to the end of the drainage element 10′ with an opening in communication with the pipe 23. In some cases, the end cap 13 may be have a jaw or jaws that will cause the cap to lock within the pipe 23 and eliminate the need for gluing of the end cap 13 to the end of the drainage element 10′. Further, each end cap 13′ may be configured to form a part of a coupling for interconnecting individual drainage elements 10′ together lengthwise when in place, for example in a trench.

The cross-section of the drainage element may be made approximately square or rectangular in cross-sectional shape wherein the base of the cross-section is a multiple of the height of the cross-section. Further, the pipe may be located within the cross-section of the drainage element so that there is more or less of a mass of expanded polymeric elements 11 above or below the pipe.

Referring to FIG. 6, the self-supporting unit 26 is made of a plurality of synthetic (i.e. expanded polymeric) loose fill elements 27 and an adhesive 28 on the elements 27 adhering the elements 27 into an elongated mass having a predetermined cross-sectional shape, for example, a square shape as shown.

The self-supporting unit 26 may also have a perforated pipe (not shown) extending within the mass for conducting a flow of liquid therethrough.

Referring to FIG. 5, an apparatus 29 for making the self-supporting unit 26 includes a hopper 30 having a funnel-shaped outlet 31 for delivering a supply of aggregate in the form of expanded polymeric loose fill elements 27 under gravity and a plurality of longitudinally arranged endless conveyor belts 32 defining a passageway 33 of predetermined cross-sectional shape for receiving a flow of loose fill elements from the hopper 30. For example, two pairs of parallel conveyor belts 32 are disposed to define a passageway 33 of rectangular, e.g. square, shape for receiving and conveying the loose fill elements 27.

The conveyor belts 32 are sized to form an inlet 34 at one end of the passageway 33 for passage of the loose fill elements 27 from the outlet 31 of the hopper 30. As shown, the topmost conveyor belt 32 is shorter than the other three conveyor belts 32 to provide the inlet 34 to the passageway 33.

The conveyor belts 32 are driven in synchronism with each other via suitable drives and transmissions (not shown) in order to convey the loose fill elements 27 from the inlet 34 to an outlet 35 at the ends of the conveyor belts 32. Typically, the conveyor belts 32 are disposed in parallel to define a passageway of constant cross-section. However, one or both pairs of oppositely disposed conveyor belts may be disposed in converging relation to each other to define a passageway of decreasing cross-section to compress the mass of loose fill elements passing through the passageway 33.

The apparatus 29 also has a means 36 for spraying an adhesive onto the flow of expanded polymeric elements 27. This means 36 may be disposed within the hopper 30 along with an agitator for agitating the elements 27 after being sprayed with adhesive to avoid clumping and premature adhesion of the elements 27 together. Alternatively, the means for spraying 36 the adhesive may be located at the inlet 34 to the passageway 33 between the conveyor belts 32.

During operation of the apparatus 29, the longitudinally arranged endless conveyor belts 32 move the adhesive-coated expanded polymeric elements 27 longitudinally along the passageway 33 while pressing the expanded polymeric elements 27 against each other to form a cohesive mass having a cross-sectional shape corresponding to the cross-sectional shape of the passageway 33. The belts 32 also expel the cohesive mass as a self-supporting unit from the outlet 35 of the passageway 33.

The apparatus may also have a heater 37, such as a radiant heater, disposed within the lowermost conveyor belt 32 for heating the upper run of the belt 32 in order to transfer heat into the passageway 33 for drying of the adhesive within the passageway 33. Alternatively, the heater may be disposed at the inlet 34 for transferring heat into the mass of elements 27.

Each conveyor belt 32 may have a Teflon® coating thereon to reduce the risk of having the adhesive accumulate thereon. Also, a scraping mechanism (not shown) may be employed for removal of any adhesive on a conveyor belt 32.

After being expelled from the apparatus 29, the resulting self-supporting unit 26 may be placed in a shipping sleeve (not shown) for shipment or storage. Alternatively, the self-supporting unit 26 may be stored as is for a time sufficient to allow the adhesive to fully dry. Also, the self-supporting unit 26 may be passed through an oven for heating to a suitable temperature to shorten the time for the adhesive to fully dry throughout the cross-section of the unit 26.

The drainage elements that are fabricated in accordance with the above techniques may be particularly utilized in ground for the storage of excess rainwater. In this respect, during a heavy rain storm, in ground surfaces may become so water logged that any further rainwater, instead of being absorbed within the ground, runs off into streams, sewers, streets and the like and eventually to an ocean. In order to prevent the runoff of this rainwater, a trench may be dug and two or more tiers of the drainage elements particularly those of rectangular shape may be stacked on top of each other within the trench and covered over with backfill. During a subsequent rainstorm, water would be absorbed within the drainage elements and held therein for subsequent permeation into the surrounding soil as the soil becomes less waterlogged.

In one embodiment, three or more drainage elements of rectangular shape can be placed within a trench in side-by-side relation so as to retain excess rainwater therein. In addition, a perforated pipe may be disposed within one or more of the drainage elements within an upper cross-sectional area so that as the water level reaches the level of the perforated pipe, any excess water may drain off through the pipe to an outlet such as a storm sewer.

While drainage elements of rectangular cross-sectional shape are particularly useful for accumulating excess rainwater, the drainage elements may also be of other shapes such as of circular cross-section.

In those instances where the drainage elements are used to retain rainwater, end caps of solid construction can be secured to the ends of the drainage elements in order to retain water within the drainage elements.

The invention thus provides a self-supporting unit that can be fabricated from synthetic aggregate without the need for an enveloping sleeve. The invention also provides a relatively easy technique for making bale-shaped drainage elements with or without a pipe extending within the drainage element.

What is claimed is:

1. A method of making a self-supporting unit comprising the steps of
directing a flow of aggregate of expanded polymeric elements having a coating of an adhesive thereon into a passageway of predetermined cross-sectional shape;
moving the polymeric elements longitudinally along said passageway while compressing the polymeric elements against each other to form a cohesive mass having a cross-sectional shape corresponding to said cross-sectional shape of said passageway;
passing the shaped cohesive mass of polymeric elements out of said passageway; and
drying the shaped cohesive mass to dry said adhesive and to form a self-supporting unit.

2. A method as set forth in claim 1 further comprising the step of cutting the shaped unit into discrete individual predetermined lengths.

3. A method as set forth in claim 1 wherein said predetermined cross-sectional shape is rectangular.

4. A method as set forth in claim 1 wherein said adhesive is a water soluble starch based adhesive

5. A method of making a drainage element comprising the steps of
positioning a tube of material having at least one water permeable section on a tubular sleeve;
closing a free end of the tube of material;
supplying an aggregate of expanded polymeric elements into the tube of material while simultaneously moving the tube of material from the sleeve to form a tubular unit, said polymeric elements having a coating of an adhesive thereon for adhering contiguous polymeric elements together;
closing the tube of material upstream of the supplied polymeric elements to retain said polymeric elements within the tube of material and to form a tubular unit;
shaping the tubular unit into an approximately rectangular cross-sectional shape; and
thereafter drying the shaped unit at a temperature sufficient to cure the adhesive and to adhere contiguous polymeric elements together.

6. A method as set forth in claim 5 wherein said tube of material has at least a first part-circumferential portion having a plurality of openings therein for passage of water therethrough and a second part-circumferential portion having a porosity to prevent the passage of dirt therethrough.

7. A method as set forth in claim 5 further comprising the step of cutting the shaped unit into discrete individual predetermined lengths to form a plurality of drainage elements.

8. A method of making a drainage element comprising the steps of
positioning a tube of material having at least one water permeable section on a tubular sleeve;
positioning an elongated length of pipe within the tubular sleeve;
closing a free end of the tube of material onto a forward end of the pipe;
supplying an aggregate of expanded polymeric elements into the tube of material and about the pipe while simultaneously moving the tube of material and pipe from the sleeve, said polymeric elements having a coating of an adhesive thereon for adhering contiguous polymeric elements together;
closing the tube of material onto the pipe upstream of the supplied mass of polymeric elements to retain said polymeric elements within the tube of material and about the pipe to form a tubular unit;
shaping the tubular unit into a cross-sectional shape deformed from a circular shape; and
thereafter drying the shaped unit at a temperature sufficient to cure the adhesive and to adhere contiguous polymeric elements together.

9. A method as set forth in claim 8 wherein the tubular unit is shaped into an approximately rectangular cross-sectional shape.

10. A method of making bale-shaped drainage elements comprising the steps of
positioning a tube of material having at least one water permeable section on a tubular sleeve;
positioning an elongated length of pipe within the tubular sleeve;
closing a free end of the tube of material onto a forward end of the pipe;
supplying an aggregate of expended polymeric elements into the tube of material and about the pipe while simultaneously moving the tube of material and pipe from the sleeve, said polymeric elements having a coating of an adhesive thereon for adhering contiguous polymeric elements together;
closing the tube of material onto the pipe upstream of the supplied polymeric elements to retain said polymeric elements within the tube of material and about the pipe to form a tubular unit;
shaping the tubular unit into a cross-sectional shape deformed from a circular shape;
thereafter drying the shaped unit at a temperature sufficient to cure the adhesive and to adhere contiguous polymeric elements together; and
cutting the shaped unit into discrete individual predetermined lengths to form a plurality of drainage elements.

11. A method as set forth in claim 10 wherein the tubular unit is shaped into an approximately rectangular cross-sectional shape.

12. A method as set forth in claim 11 further comprising the step of placing an end cap over each end of a drainage unit to close each respective end of the drainage unit, each said end cap having an opening in alignment with the pipe within the drainage unit.

13. A method as set forth in claim 12 further comprising the step of gluing each end cap to a respective end of the tubular unit.

14. A self-supporting unit comprising
a plurality of expanded polymeric elements; and
an adhesive on said elements adhering said elements into an elongated self-supporting mass having a predetermined cross-sectional shape and length.

15. A self-supporting unit as set forth in claim 14 wherein said cross-sectional shape is selected from one of a triangular shape, a polygonal shape, a circular shape and an oval shape.

16. A self-supporting unit as set forth in claim 14 wherein said adhesive is a water soluble adhesive.

17. A self-supporting unit as set forth in claim 14 wherein said adhesive is a water soluble starch based adhesive

18. A self-supporting unit as set forth in claim 14 further comprising a perforated pipe extending within said mass for conducting a flow of liquid therethrough.

19. A self-supporting drainage element comprising
a plurality of expended polymeric elements;
a water soluble starch based adhesive on said elements adhering said elements into an elongated mass having a predetermined cross-sectional shape; and
a perforated pipe extending within said mass for conducting a flow of liquid therethrough.

20. A drainage element comprising
a tube of material having at least one water permeable peripheral section and a mass of expanded elements of polymeric material within said tube of material, said elements having a coating of an adhesive thereon adhering contiguous elements together; and
said tube of material and said elements defining a unit characterized in having a cross-sectional shape deformed from a circular shape.

21. A drainage element as set forth in claim 20 wherein said cross-sectional shape is approximately rectangular.

22. A drainage element as set forth in claim 20 further comprising an end cap secured to each respective end of said unit to retain said elements within said tube of material.

23. A drainage element as set forth in claim 22 wherein said end cap is porous.

24. A drainage element as set forth in claim 20 further comprising an elongated perforated pipe extending within said unit and an end cap secured to each respective end of said unit to retain said elements within said tube of material, said end cap having an opening in communication with said pipe.

25. An apparatus comprising
a hopper for delivering a flow of expanded polymeric elements;
means for spraying an adhesive onto the flow of polymeric elements; and
a plurality of longitudinally arranged endless conveyor belts defining a passageway of predetermined cross-sectional shape for receiving a flow of polymeric elements from said hopper with adhesive thereon, for moving the polymeric elements longitudinally along said passageway while pressing the polymeric elements against each other to form a cohesive mass having a cross-sectional shape corresponding to said cross-sectional shape of said passageway and for expelling the cohesive mass as a self-supporting unit from said passageway.

26. An apparatus as set forth in claim 25 further comprising a heater for heating at least one of said conveyor belts for drying of the adhesive within said passageway.

27. An apparatus as set forth in claim 25 wherein each said conveyor belt has a Teflon coating thereon.

28. An apparatus as set forth in claim 25 wherein opposed pairs of said plurality of conveyor belts are disposed in converging relation to each other to define a passageway of decreasing cross-section to compress said cohesive mass passing therethrough.
